(19) United States
(12) Patent Application Publication
(10) Pub. No.: US 2024/0405289 A1
(43) Pub. Date: Dec. 5, 2024

(54) ELECTRODE DESIGN FOR CONTINUOUS ROLL-TO-ROLL LAMINATION

(71) Applicant: Our Next Energy, Inc., Novi, MI (US)

(72) Inventor: Qingcheng Zeng, Fremont, CA (US)

(21) Appl. No.: 18/732,038

(22) Filed: Jun. 3, 2024

Related U.S. Application Data
(60) Provisional application No. 63/505,801, filed on Jun. 2, 2023.

(51) Int. Cl. H01M 10/0585; H01M 4/04; H01M 4/66; H01M 50/46

(52) U.S. Cl. CPC H01M 10/0585; H01M 4/0435; H01M 4/661; H01M 4/667; H01M 50/46

(57) ABSTRACT

A cell that includes a pouch, a cathode including a cathode current collector disposed between two cathode active material layers, an anode including an anode current collector disposed between two anode active material layers, and separator disposed between the cathode and the anode. A first dimension in an X-axis and/or Y-axis of the separator, anode current collector and cathode current collector are the same. A method of manufacturing the cell includes continuous roll to roll lamination of cell components.

### BACKGROUND

### Technical Field

The present disclosure generally relates to battery cells and more particularly to an electrode design for a cell that enables continuous roll to roll lamination and improved stacking speed.

### Description of the Related Art

Battery cells have been used in a wide array of applications including electric vehicles and energy storage systems to provide a source of energy. The battery cells charge and discharge by moving metal ions between a positive electrode and a negative electrode. In a typical lithium-ion secondary battery, an active material capable of holding lithium is introduced into the positive electrode and the negative electrode, and charging/discharging is performed by exchanging lithium ions between the positive electrode active material and the negative electrode active material.

### BRIEF SUMMARY

According to an embodiment of the present disclosure, a cell is disclosed. The cell includes a pouch, a cathode including a cathode current collector disposed between two cathode active material layers, an anode including an anode current collector disposed between two anode active material layers, and separator disposed between the cathode and the anode. A first dimension in an X-axis and/or Y-axis of the separator, anode current collector and cathode current collector are configured to be the same. Advantageously, this may enable stacking of components of the cell using a mechanical positioning system.

In one embodiment, a second dimension, in the X-axis and/or Y-axis, of the two cathode active material layers may be smaller than the second dimension of the two anode active material layers in the X-axis and/or Y-axis. Alternatively, the second dimension may be larger and the cathode active material layer may be protected from falling off.

According to an embodiment, a method for fabricating a cell is disclosed. The method includes disposing a cathode current collector between two cathode active material layers to provide a cathode, disposing an anode current collector between two anode active material layers to provide an anode, disposing the separator between the cathode and the anode to form a multi-layer of the cathode, the separator, and the anode, and performing a continuous roll to roll lamination of the multi-layer. The multi-layer is then dimensioned by cutting through it such that the separator, the anode current collector and the cathode current collector have the same or substantially similar dimensions in the X-axis and/or Y-axis.

According to an embodiment, a tape is disclosed. The tape includes a first film layer, a second middle adhesive layer, and a third acrylic base adhesive layer. The second middle adhesive layer is configured to move outwardly (in the X-axis) upon the tape receiving a force in the Z-axis while the first film layer and third acrylic base adhesive layer stay intact or substantially intact.

### BRIEF DESCRIPTION OF THE DRAWINGS

To easily identify the discussion of any particular element or act, the most significant digit or digits in a reference number refer to the figure number in which that element is first introduced.

FIG. 1A depicts a cross sectional view of an anode and cathode in a single stack in accordance with an illustrative embodiment.

FIG. 1B depicts a top view of a pouch and electrode tabs in accordance with an illustrative embodiment

FIG. 2 depicts a sketch showing cross sectional views of electrodes in one or more manufacturing flows in accordance with an illustrative embodiment.

FIG. 3 depicts an exploded view showing top surfaces of a cell and components of the cell in accordance with an illustrative embodiment.

FIG. 4 depicts a sketch showing cross sectional views of electrodes in one or more manufacturing flows in accordance with an illustrative embodiment.

FIG. 5 depicts a side view of a system showing a lamination in accordance with an illustrative embodiment.

FIG. 6 depicts a sketch showing cross sectional views of electrodes in one or more manufacturing flows including the application of a spray in accordance with an illustrative embodiment.

FIG. 7 depicts a sketch showing cross sectional views of electrodes in one or more manufacturing flows including the application of a spray and a tape in accordance with an illustrative embodiment.

FIG. 8 depicts a sketch showing cross sectional views of electrodes in one or more manufacturing flows including a stacking operation and a second lamination in accordance with an illustrative embodiment.

FIG. 9 depicts a cross sectional view showing a tape in accordance with an illustrative embodiment.

FIG. 10 depicts a top view showing an active material and a current collector in accordance with an illustrative embodiment.

FIG. 11 depicts a top view of an active material, a current collector and a tape in accordance with an illustrative embodiment.

FIG. 12 depicts a top view of an active material, a current collector and a tape in accordance with an illustrative embodiment.

FIG. 13 depicts a cross sectional view of a tape in accordance with an illustrative embodiment.

FIG. 14 depicts a cross sectional view of a tape in accordance with an illustrative embodiment.

FIG. 15 depicts a cross sectional view of a tape in accordance with an illustrative embodiment.

FIG. 16 depicts a cross sectional view of an electrode showing illustrating a compression of a tape in accordance with an illustrative embodiment.

FIG. 17 depicts a cross sectional view of an electrode showing illustrating a compression of a tape in accordance with an illustrative embodiment.

FIG. 18 illustrates a routine 1800 in accordance with one embodiment.

FIG. 19 depicts a functional block diagram of a computer hardware platform in accordance with an illustrative embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, and/or components have been described at a relatively high-level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a cell. As used herein, the term “vertical” describes an orientation that is arranged perpendicular to the first surface of a cell.

As used herein, the terms “coupled” and/or “electrically coupled” are not meant to mean that the elements must be directly coupled together—intervening elements may be provided between the “coupled” or “electrically coupled” elements. In contrast, if an element is referred to as being “directly connected” or “directly coupled” to another element, there are no intervening elements present. The term “electrically connected” refers to a low-ohmic electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used, and structural or logical changes may be made without departing from the spirit and scope defined by the claims. The description of the embodiments is not limiting. In particular, elements of the embodiments described hereinafter may be combined with elements of different embodiments.

For the sake of brevity, conventional techniques related to battery cells and their fabrication may or may not be described in detail herein. Moreover, the various tasks and process steps described herein can be incorporated into a more comprehensive procedure or process having additional steps or functionality not described in detail herein.

Turning now to an overview of technologies that generally relate to the present teachings, battery cells comprise an anode, a cathode, and a separator. The size of the cell may be determined by factors such as the desired capacity of the battery and the voltage output. The separator, which is placed between the anode and cathode to prevent them from touching and shorting out may typically be designed to be very thin and lightweight. The illustrative embodiments recognize that in some battery cells such as in lithium-ion cells, the anode may be designed to have a larger surface area than the surface area of the cathode such that during charging all lithium ions that may be transferred from the cathode to the anode may be accommodated in the anode. This may prevent or alleviate the anode from becoming overcharged, which can lead to the formation of dendrites and other forms of lithium plating which can be dangerous and can reduce the lifespan of the battery cell. The illustrative embodiments further recognize that the separator may be designed to be e slightly larger in an XY plane (perpendicular to the thickness) relative to the sizes of the anode and cathode to prevent the two electrodes from coming into direct contact with each other which can result in short-circuiting and potentially hazardous conditions. However, designing the components of the cells to have different sizes can make manufacturing difficult since complex machines may have to be employed to detect and keep track of the dimensions and relative positioning of the components prior to assembling the components in large scale battery cell manufacturing plants.

The illustrative embodiments disclose a cell that includes a pouch, a cathode including a cathode current collector disposed between two cathode active material layers, an anode including an anode current collector disposed between two anode active material layers, and separator disposed between the cathode and the anode. A first dimension in an X-axis and/or Y-axis of the separator, anode current collector and cathode current collector are the same.

In an aspect, a second dimension, in the X-axis and/or Y-axis, of the two cathode active material layers is smaller than the second dimension of the two anode active material layers in the X-axis and/or Y-axis.

In another aspect, the second dimension, in the X-axis and/or Y-axis, of the two cathode active material layers is larger than the second dimension of the two anode active material layers in the X-axis and/or Y-axis.

The illustrative embodiments further disclose a method of manufacturing a cell by roll to roll lamination including providing a pouch, disposing a cathode current collector between two cathode active material layers to provide a cathode, disposing an anode current collector between two anode active material layers to provide an anode, dimensioning a separator, the anode current collector and the cathode current collector to be the same in the X-axis and/or Y-axis, disposing the separator between the cathode and the anode, and forming a multi-layer of the cathode, the separator, the anode, and the separator by positioning the multilayer on a laminating base using a mechanical positioning system which is controlled based on knowledge about the relative dimensions of the multi-layer and performing a roll to roll lamination of the multi-layer.

### Example Architecture

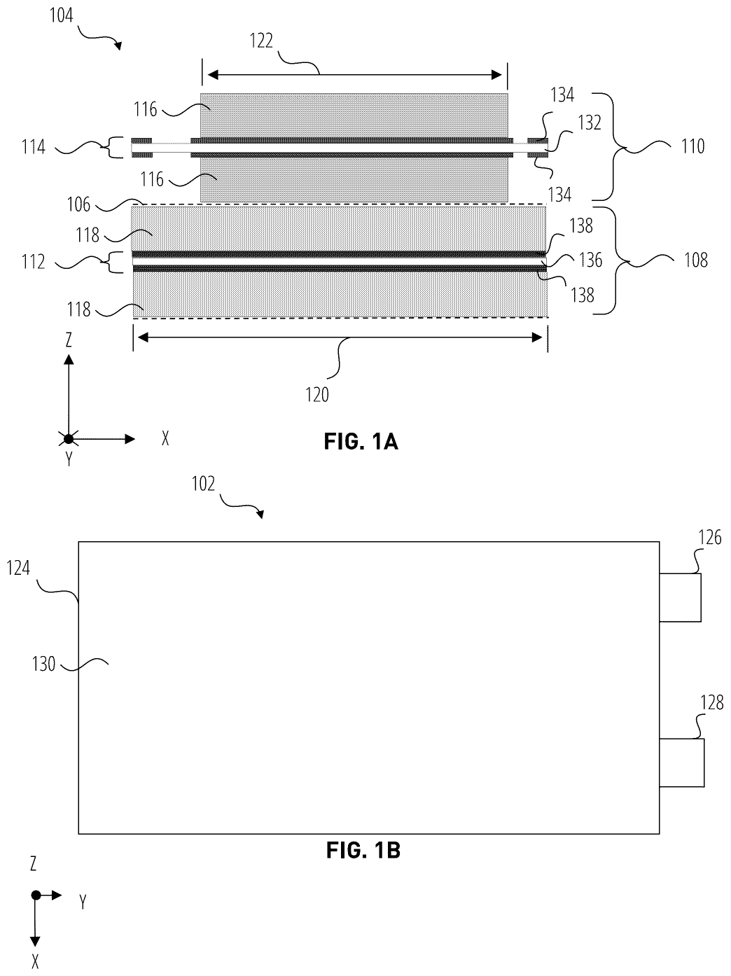

Turning to FIG. 1A and FIG. 1B, a general structure of at least a portion of the a cell 102 is shown. FIG. 1A illustrates a cross section of an example a mono cell 104, a plurality of which may be disposed in a pouch 124 (FIG. 1B) to form a cell 102. The cell 102 may therefore comprise a pouch 124 extending along a first axis (X-axis) to define a width, a second axis (Y-axis) orthogonal to the first axis to define a length, and a third axis (Z-axis) orthogonal to the first and second axes to define a thickness. The cell 102 may further comprise a cathode 110 which may include a cathode current collector 114 disposed between two cathode active material layers 116; an anode 108 including an anode current collector 112 disposed between two anode active material layers 118; and a separator 106 disposed between the cathode 110 and the anode 108. A first dimension 120 in the X-axis (width) and/or Y-axis (length) of the separator 106, anode current collector 112 and cathode current collector 114 may be the same (for example within 0±1 mm of each other, or within 0±0.5 mm of each other, or within within 0±0.1 mm of each other). Advantageously, by making the first dimension the same or substantially the same, positioning of components of the cells may be performed easily with mechanical tools by virtue of mechanically manipulating similar or common edges of the components due to the similar dimensions as opposed to programmatically sensing edges using complex dimension detection technologies were the dimensions to be different. This may enable continuous roll to roll lamination processes in manufacturing wherein components of the cell may be laminated in a continuous process and cut at predetermined intervals to obtain a final product such as a mono cell, a plurality of which may also be mechanically stacked easily based on similar edges. This may be prevent or alleviate discrete “cut-align-and-laminate” flows which may involve cutting cell components of dissimilar sizes, aligning the cut cell components based on complex dimension detection techniques (such as some optical dimension sensing techniques) due to dissimilar edges, laminating the aligned components to get a first mono cell, repeating the “cut-align-and-laminate” flow for other mono cells, and aligning the mono cells into a stack together based on the complex dimension detection techniques.

In an aspect herein, the continuous roll to roll lamination flow may increase a stacking speed by 5× or even more relative to conventional speeds. In some embodiments, the speed may be increased from 0.6 sec/electrode to <0.05 sec/electrode.

FIG. 1B illustrates a top view of a pouch 124 or housing of a cell 102 described herein. The pouch 124 may comprise a large wall surface 130 that may be parallel to the YX plane, the YX plane described herein being a two-dimensional plane in three-dimensional space that is perpendicular to the Z-axis (thickness) and is perpendicular to a surface or edge of the cell that includes the positive tab 128 and/or negative tab 126 of the cell. The XZ plane may thus be parallel to the edge of the cell that include the positive and/or negative tabs. The X and Y axes may be parallel to the large wall surface 130. The pouch 124 may house a mono cell 104 such as is shown in FIG. 1A in a single pouch battery cell or a stack of mono cells 104 in a multilayer or stacked pouch cell.

Turning back to FIG. 1A, the cell may include, in an illustrative embodiment, a second dimension 122, in the X-axis and/or Y-axis (width and/or length), of the two cathode active material layers that is smaller than the second dimension of the two anode active material layers in the X-axis and/or Y-axis. For example, the difference between the size of the two anode active material layers in the X and/or Y-axes and the size of the two cathode active material layers in the X and/or Y-axes respectively may be from 0-6 mm, such as from 1-5 mm, or from 2-4 mm. However, the second dimension 122 may alternatively be larger in other embodiments (for example larger by a value from 0-5 mm, or from 1-4 mm, or from 2-3 mm).

Further, the anode current collector 112 and/or cathode current collector 114 may be polymer current collectors. Specifically, the cathode current collector may be a polymer cathode current collector and may include a metalized polymer comprising a first polymer layer 132 disposed between two first metal layers 134. The first polymer layer 132 may comprise polyethylene terephthalate (PET), for example, the two metal layers may comprise aluminum.

The anode current collector 112 may also be a polymer anode current collector that includes a metallized polymer which may comprise a second polymer layer 136 disposed between two second metal layers 138. The second polymer layer 136 may comprise polypropylene (PP), for example, and the two second metal layers 138 may comprise copper. Other materials for the metal layers may comprise nickel, titanium or zinc.

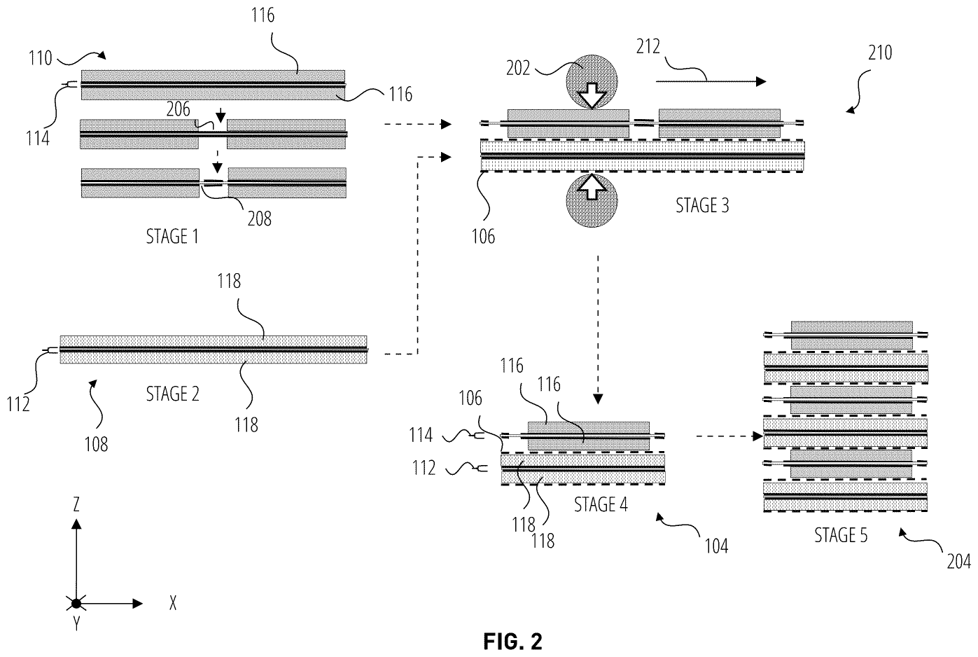

FIG. 2 illustrates cross sectional views of electrodes in one or more manufacturing flows in accordance with an illustrative embodiment. In a first stage of FIG. 2 (STAGE 1), a cathode 110 may be provided comprising a cathode active material layer 116 and a cathode current collector 114 such as a polymer cathode current collector. In STAGE 1, a portion of the cathode active material layer 116 may be removed, for example by laser abrasion, to generate a removed cathode active material layer 206 and a portion of the first metal layer 134 may be removed to generate a removed first metal layer 208.

In STAGE 2, an anode 108 comprising an anode current collector 112 and anode active material layers 118 may be provided. The anode current collector 112 may be a polymer anode current collector.

In STAGE 3, at least one separator 106 may be disposed between the cathode 110 and the anode 108, the cathode comprising the removed cathode active material layer 206 and the removed first metal layer 208. A separator 106 may also be disposed beneath the anode 108. Using a simple mechanical alignment system (not shown), the cathode 110, anode 108 and separator 106 may be aligned together based on similar dimensions, for example in the Y-axis, of the separator 106, anode current collector 112 and cathode current collector 114. A roll press 202 (or other pressure applicator, or pressure and heat applicator) may be used to laminate the components together in a continuous manner as the components move in the movement direction 212. At a first end 210, a cutting tool (not shown) may be used to cut the components in the Z-axis direction at a predetermined interval to form a mono cell 104 in STAGE 4. The mono cell 104 of FIG. 2 may comprise at least a cathode, an anode and two separators. The predetermined interval may be the first dimension 120 such as a width of the mono cell 104 in the X-axis direction. A plurality of other mono cells may be formed by cutting at the first end 210 to generate a mono cell stack 204 in STAGE 5. The stacking of mono cells 104 may advantageously be performed based on the same first dimension 120, and thus edges of the separator 106, anode current collector 112, and cathode current collector 114. A mechanical stacking can therefore be performed at a significantly increased stacking speeds as opposed to using an X-Y table and a camera to detect dimensions prior to stacking. A stack of mono cells may be placed in a pouch to form a cell. It can be seen in the embodiment of FIG. 2 that the width of two cathode active material layers 116 in STAGE 4 is smaller than the width of the two anode active material layers 118. This may also be true of their respective lengths in the Y-axis direction.

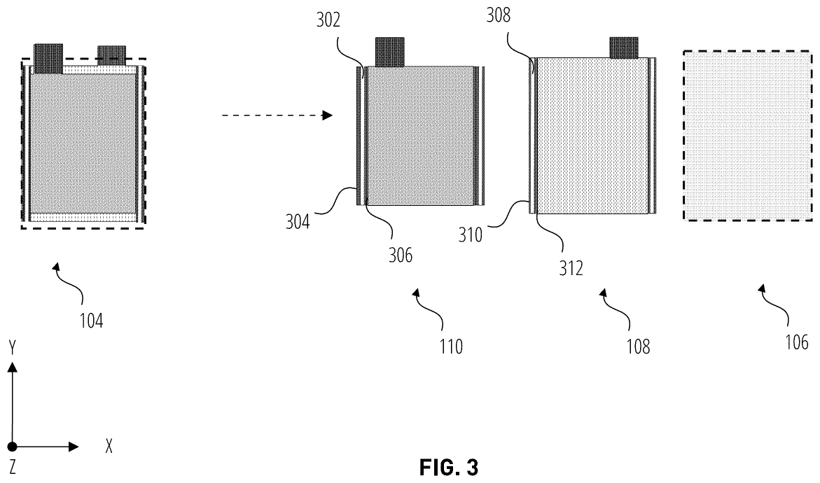

FIG. 3 illustrates an exploded view showing top surfaces of a mono cell 104 and components thereof in accordance with an illustrative embodiment. The exploded view shows the separator 106, the anode 108, and the cathode 110. The views of the cathode 110 and anode 108 show a first abrasion trace 302 and a second abrasion trace 308 comprising removed active material layers and removed metal layers from both the cathode and the anode, though this is not meant to be limiting to all embodiments. Advantageously the removal of layers may enable demarcating of sections of the multi-layer (e.g., of cathode, the separator and the anode) that may be cut during the continuous roll to roll lamination and making it easier and faster to cut through the multi-layer since there may be less material to traverse in the Z-direction. The removal may also enable, in the cathode 110 the exposure of the first metal layer 134 to form the first exposed first metal layer 304 and the second exposed first metal layer 306 which may be isolated from each other. The removal may also enable, in the anode 108 the exposure of the second metal layer 138 to form the first exposed second metal layer 310 and the second exposed second metal layer 312 which may be isolated from each other. The isolation may enable the size, in the X and/or Y-axis of the metal layers of the current collectors that are in contact with their corresponding active material layers to be the same or substantially the same as the respective sizes of their corresponding active material layers while making the effective size in the X and/or Y axis direction of the whole current collector to be the same as the size of the separator (which may help in mechanical alignment as discussed herein). For the isolation, both sides of the current collector and thus electrode may undergo abrasion and therefore abrasion may occur before lamination. The edges of the current collector with the isolation may therefore be non-conductive. In another aspect, all the metal layers of the current collectors not in contact with the active material layers may be removed with the polymer layers remaining to aid in mechanical alignment. In yet another aspect, the dimensions of the anode in the Y-axis (direction without the tab) may be the same as the corresponding dimensions of the separator.

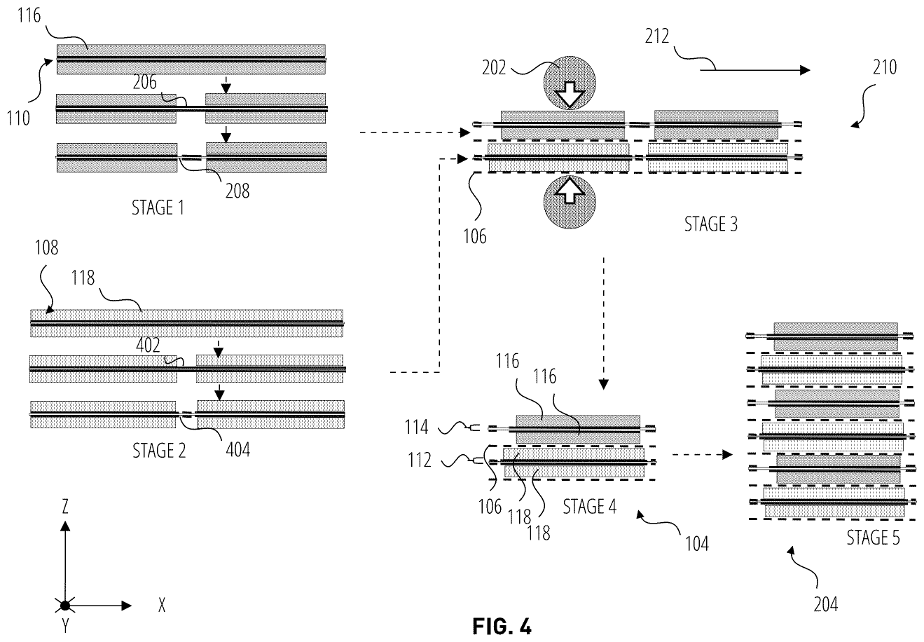

FIG. 4 illustrates cross sectional views of electrodes in one or more manufacturing flows in accordance with an illustrative embodiment. Unlike in FIG. 2, an abrasion trace may be formed for both the cathode 110 and the cathode. Thus, in STAGE 1 of FIG. 4, a cathode 110 may be provided comprising a cathode active material layer 116 and a cathode current collector 114 such as a polymer cathode current collector. In STAGE 1, a portion of the cathode active material layer 116 may be removed, to generate a removed cathode active material layer 206 and a portion of the first metal layer 134 may be removed to generate a removed first metal layer 208.

In STAGE 2, an anode 108 comprising an anode current collector 112 and anode active material layers 118 may be provided. The anode current collector 112 may be a polymer anode current collector. A portion of the anode active material layer 118 may be removed, to generate a removed anode active material layer 402 and a portion of the second metal layer 138 may be removed to generate a removed second metal layer 404.

In STAGE 3, a separator 106 may be disposed between the cathode 110 and the anode 108. A separator 106 may also be disposed beneath the anode 108. A roll press 202 may be used to laminate the components together in a continuous manner as the components move in the movement direction 212. At a first end 210, a cutting tool (not shown) may be used to cut the components in the Z-axis direction at a predetermined interval to form a mono cell 104 in STAGE 4. A plurality of other mono cells may be formed by cutting at the first end 210 to generate a mono cell stack 204 in STAGE 5. The stacking of mono cells 104 may advantageously be performed based on the same first dimension 120, and thus edges of the separator 106, anode current collector 112, and cathode current collector 114. A mechanical stacking can therefore be performed at a significantly increased stacking speeds as opposed to using an X-Y table and a camera to detect dimensions prior to stacking. A stack of mono cells may be placed in a pouch to form a cell. It can be seen in the embodiment of FIG. 4 that the width (in the X-axis direction) of two cathode active material layers 116 in STAGE 4 is smaller than the width of the two anode active material layers 118. This may also be true of their respective lengths in the Y-axis direction.

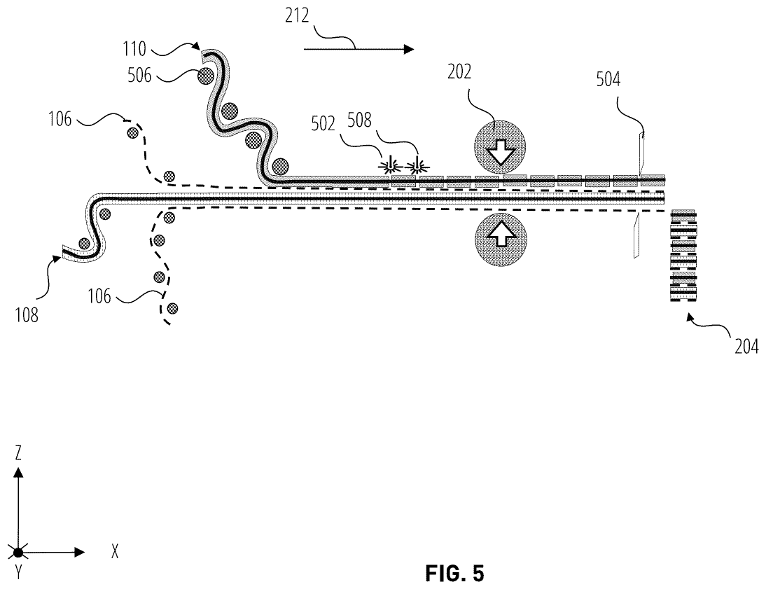

FIG. 5 illustrates a side view of a roll to roll pressing system showing a continuous lamination and intermittent cutting in accordance with an illustrative embodiment. The system may comprise a roll press 202, a first laser device 502, a second laser device 508, a plurality of rollers 506 and one or more cutting tools 504. In the system, a continuous material of cathode 110, anode 108, and one or more separators 106 may be guided by rollers 506 onto a base for lamination by the roll press 202. Prior to lamination, a first section of the continuous material (e.g., active material) may be removed using a removal tool such as the first laser device 502, and a second section of the continuous material (e.g., metal layer) may be removed using a removal tool such as the second laser device 508, after which the remaining material may be laminated continuously by the roll press 202 and cut into the mono cell stack 204 by virtue of the cutting tool 504. Thus, removal of sections of the material which may expose the metal layers of the current collectors, may also be performed in the continuous flow using the roll to roll pressing system of FIG. 5.

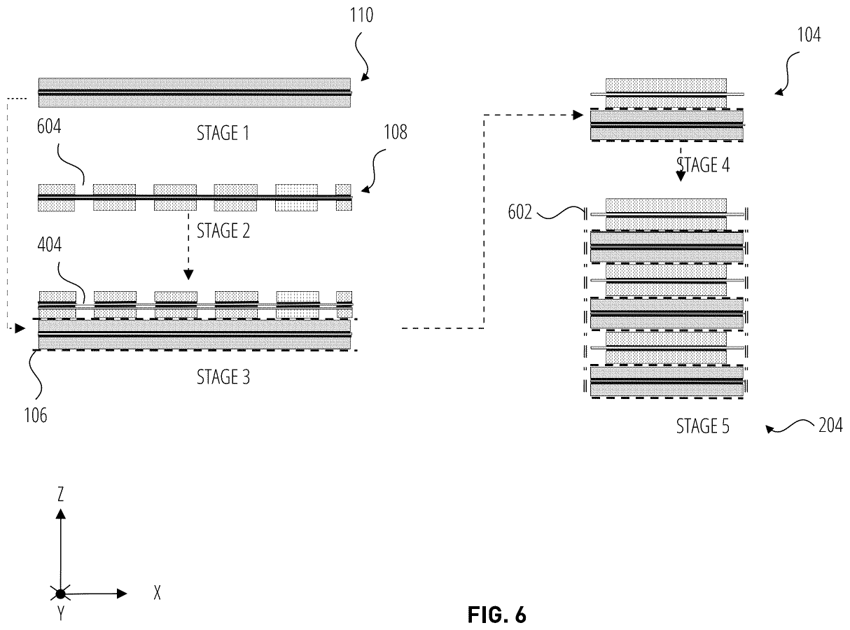

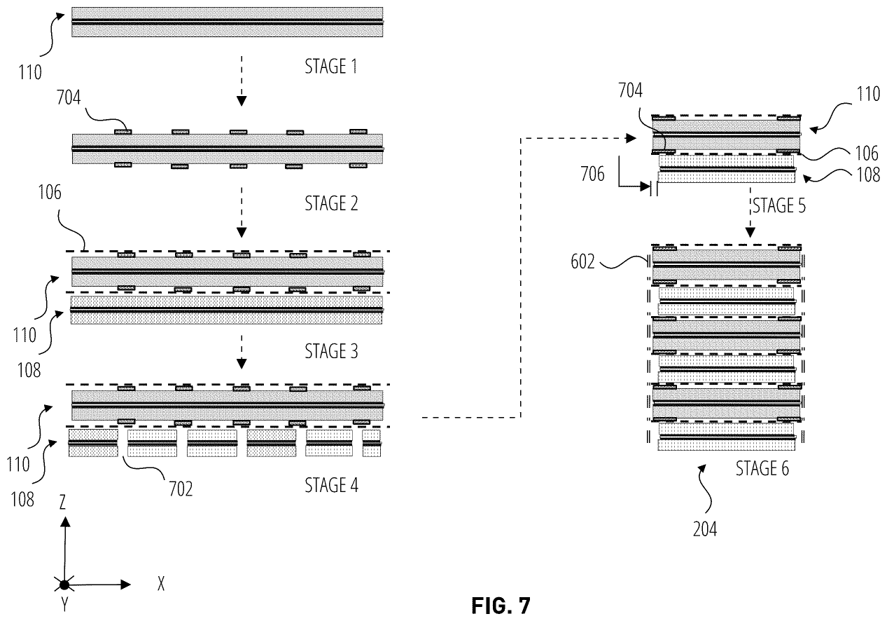

FIG. 6 and FIG. 7 illustrate cross sectional views of electrodes in one or more manufacturing flows including the application of a spray in accordance with an illustrative embodiment. As shown in STAGE 1-STAGE 5 of FIG. 6, the processes may be similar to the processes described herein with a spray 602 (such as an edge gel spray) or seal being applied to edges of the mono cell stack 204 in STAGE 5 of FIG. 6 and in STAGE 6 of FIG. 7. The spray may be applied to seal or protect exposed edges of the electrode. A spray of polymer or copolymer may secure any particles that may delaminate from the electrode, or prevent an exposed foil/metal from contact with the pouch/case/can of the cell. In FIG. 6 and FIG. 7, the cathode may be larger than the anode in the X-axis direction. Thus, applying the spray may enable the cathode active material to be held in place at the edges (YZ plane) to prevent the material from falling off.

Turning to FIG. 6, an abrasion pattern primer 704 may be formed in the anode 108 in STAGE 2 which may further comprise forming a removed second metal layer 404 formed by removing portions of the metal layer in the anode current collector in STAGE 3.

With regards to FIG. 7, a pattern primer 704 may be coated on the cathode 110 in STAGE 2 of FIG. 7 prior to applying the separator 106 to the pattern primer 704 and laminating them in STAGE 3 of FIG. 7. In STAGE 4, A material removal tool such as a laser device configured to perform laser abrasion, or a rotary cutting device may be used to remove entire sections (volume of the material spanning the thickness, in the Z-direction) of the anode 108 as dictated by the pattern of the pattern primer 704. The sections may be removed after abrasion or rotary cutting by pressurized air or vacuum, leaving the desired remaining sections as dictated by the pattern primer which may provide a sticky interface to retain the desired remaining section. Alternatively, the pattern primer 704 may signify areas where lamination may be performed such that the sections removed, where lamination was not performed may fall off after abrasion or rotary cutting. In a further aspect, the pattern primer 704 may be non-conductive and may further serve as an interface between the cathode 110 and the anode 108 to interrupt the flow of lithium ions from the cathode 110 to the anode 108, at least in the regions of the primer, which may prevent or alleviate lithium plating. The remaining material may further be cut into mono cells 104 in STAGE 5 and stacked into a mono cell stack 204 in STAGE 6. As can be seen in STAGES 5 and 6, a clearance 706 may be kept between the edge in the YZ plane of the larger electrode (larger in the X and/or Y-axis direction) and the edge in the YZ plane of the smaller electrode (smaller in the X and/or Y-axis direction). The edges of the mono cell stack 204 may be sprayed with the spray 602 in STAGE 6.

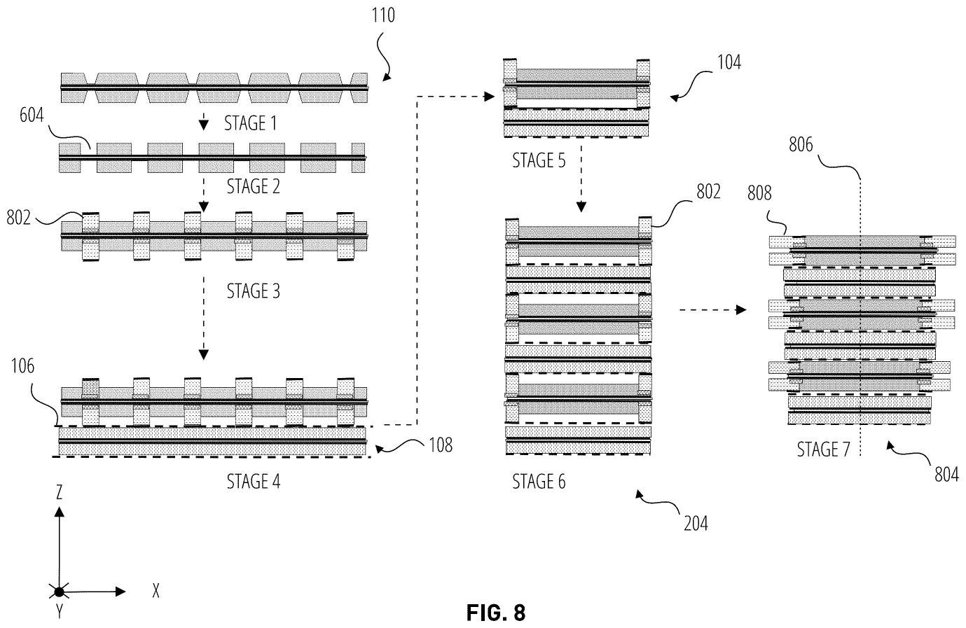

FIG. 8 illustrates cross sectional views of electrodes in one or more manufacturing flows including a stacking operation and a second lamination in accordance with an illustrative embodiment. In FIG. 8, rather than keeping a clearance 706 corresponding to the removed sections of the cathode and/or anode, a tape 802 may be inserted at the area of the removed sections of the abrasion pattern 604 as shown in STAGE 3 of FIG. 8. The anode 108, separator 106, and cathode 110 may be laminated in a first lamination process in STAGE 4 of FIG. 8 and cut into mono cells 104 in STAGE 5 to form a mono cell stack 204 in STAGE 6. The mono cell stacks 204 may further be laminated in a second lamination process in STAGE 7 of FIG. 8 into a laminated mono cell stack 804 wherein a portion of the tape 802 may be constrained to move outwardly relative to a center 806 of the mono cell stack 204 to form an extended portion 808. The extended portion 808 may aid in preventing the cathode from contacting the anode which may cause a short circuit. The extended portion 808 may also aid in heat conductivity which may be improved relative to have no extended portion 808. The portion of the tape that may move outwardly may be a middle adhesive layer as discussed herein.

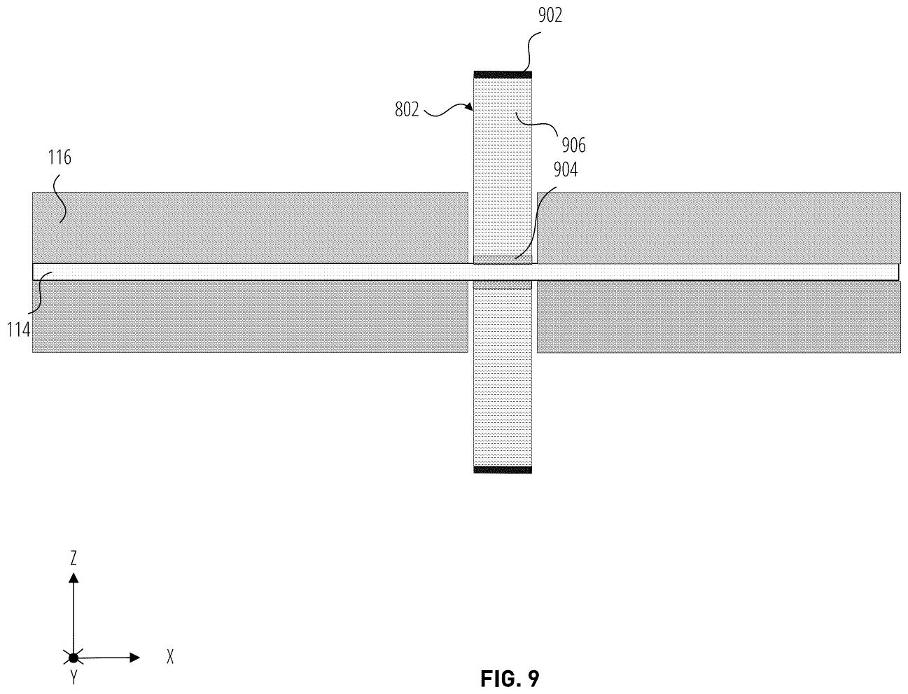

FIG. 9 illustrates a cross sectional view showing the tape 802, a cathode current collector 114 and a cathode active material layer 116.

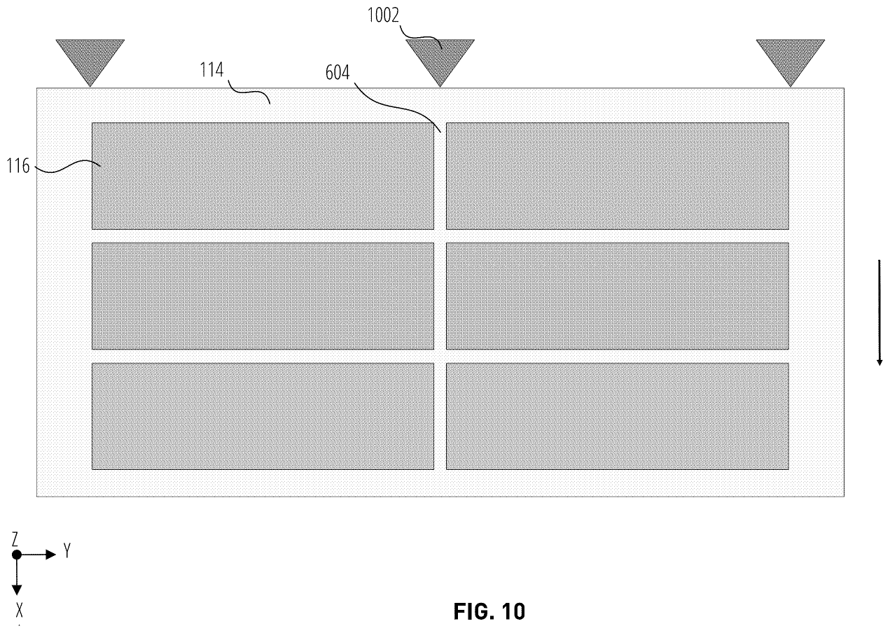

The tape 802 used herein may generally comprise a film layer 902, a base layer 904 and a middle adhesive layer 906 disposed therebetween. The base layer 904 may be placed next to the cathode current collector 114 with the film layer 902 being further away from the cathode current collector 114. The adhesive portions of the tape 802 may comprise the base layer 904 and the middle adhesive layer 906, and a back end of the tape may comprise the film layer 902. In an aspect herein, the tape may be dimensioned according to the width of the abrasion pattern 604 and placed into the pattern. Of course, the tape 802 may also be used with an anode and FIG. 9, as well as FIG. 10-FIG. 12 are not meant to be limiting to cathodes and cathode current collectors. Further, the tape may comprise other designs such as comprising the film layer 902 in addition to a single adhesive layer. In some aspects, a primer may be applied to the tape and this may bond the electrode and the separator.

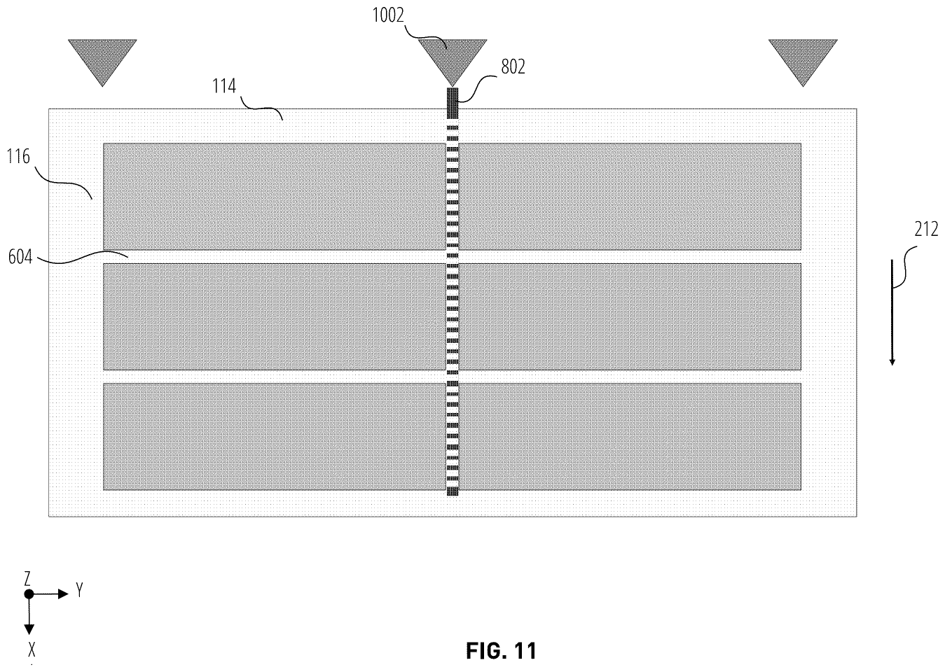

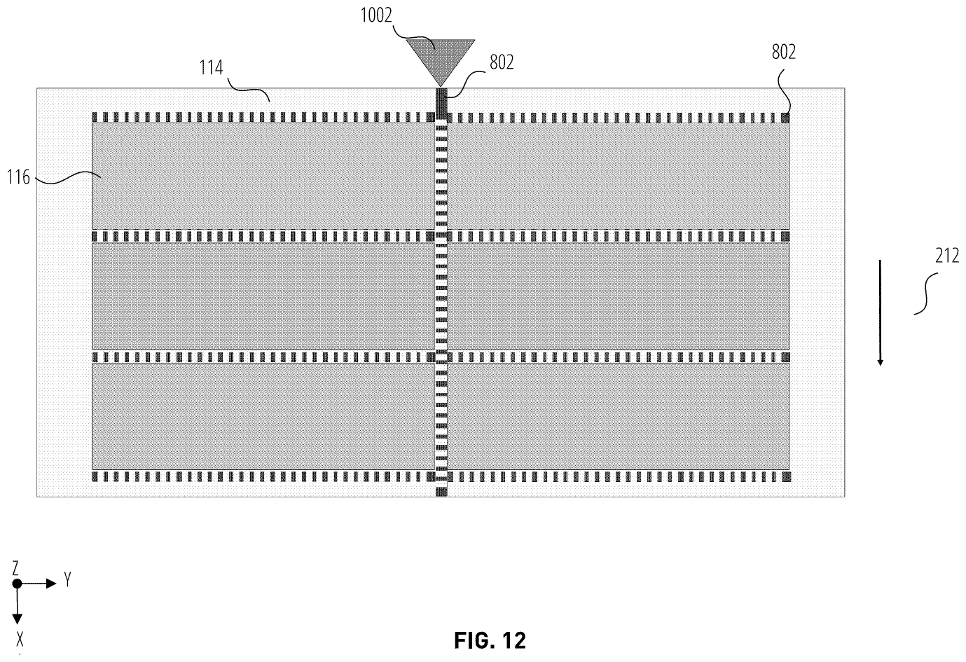

FIG. 10-FIG. 12 illustrate a top view showing an active material and a current collector in accordance with an illustrative embodiment. FIG. 10 shows the top view prior to depositing tape material in the abrasion pattern 604. In FIG. 11, the tape 802 may be coated in an abrasion pattern 604 using the coating tool 1002 as the active material and current collector move in the movement direction 212. In some aspects, the coating may be continuous and in some other aspects as shown in FIG. 11 and FIG. 12, the coating may be intermittent. FIG. 12 illustrates the top view upon completion of the coating.

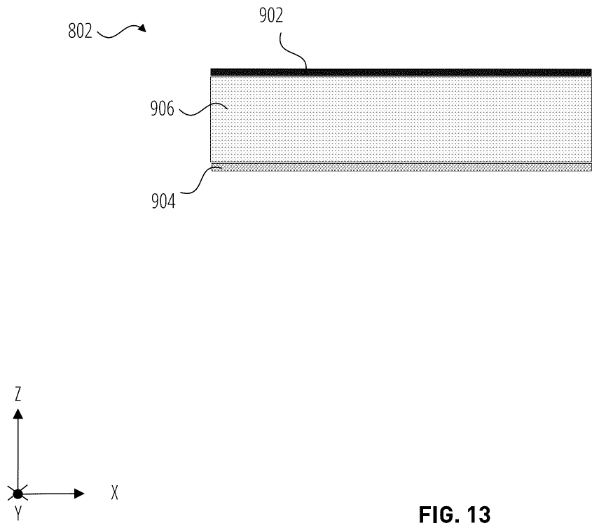

FIG. 13 illustrates a cross sectional view of a tape in accordance with an illustrative embodiment. The tape 802 may comprise a film layer 902, a base layer 904, and a middle adhesive layer 906 disposed therebetween. The film layer 902 may comprise, for example, 10-20 μm, polyethylene terephthalate (PET) or polyimide (PI) film. The middle adhesive layer 906 may be configured to melt upon application of heat and may have a thickness of, for example, 80-120 μm, heat melting temperature of about 60° C., such as from 50-70° C., or 55-65° C. or 58-62° C. The heat melting layer may be designed to keep tape intact during tape winding from a tape manufacturing process. A conventional tape design, without the middle layer, may collapse during winding, but may however, be used in some embodiments if needed.

Upon application of pressure and/or heat, the middle adhesive layer 906 may melt and move outwardly to provide the extended portion 808. The base layer 904 may be in an aspect, an acrylic base adhesive comprising a thickness of, for example, 3-10 μm. The tape 802 described herein may be dimensioned to have any desired widths in the X-axis direction, such as about 3 mm (e.g., 2-5 mm, or 2.5-4 mm).

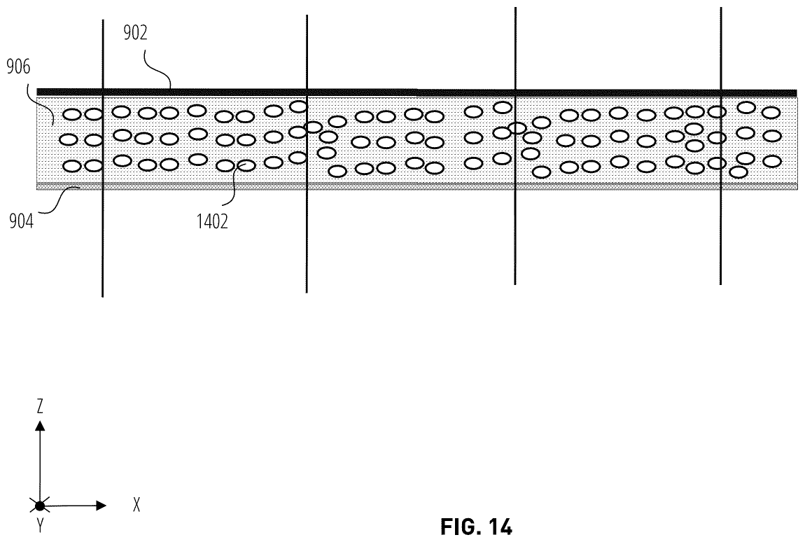

FIG. 14 illustrates a cross section of another tape further comprising a filler material 1402 disposed throughout the middle adhesive layer 906. The filler material may be a ceramic material. The film layer 902 of FIG. 14 may comprise, for example, about 10 μm (such as 8-12 μm) of thickness of (PET). The middle adhesive layer 906 may be configured to melt upon application of heat and may have a thickness of, for example, about 100 μm (such as 80-120 μm) and a be configured to melt upon application of heat and/or pressure. The base layer 904 may be in an aspect, an acrylic base adhesive comprising a thickness of, for example, about 3 μm (such as 2-5 μm). The heat melting adhesive may stay stiff to maintain shape of the tape. Blending it with the filler material may reduce the flow of the heat melting adhesive. The tape 802 may be dimensioned to have any desired widths in the X-axis direction, such as about 3 mm (e.g., 2-5 mm, or 2.5-4 mm).

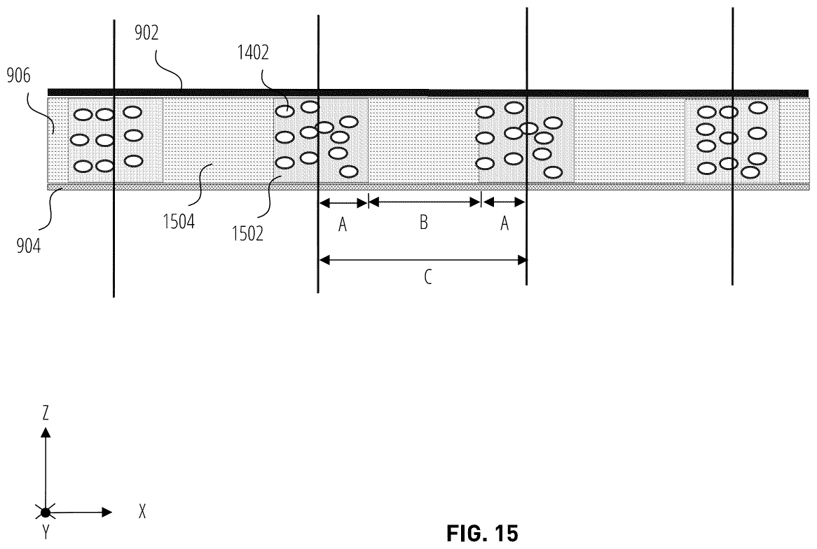

FIG. 15 illustrates a cross section of another tape wherein some sections 1502 of the middle adhesive layer 906 comprise filler material 1402 and other portions 1504 have no filler material 1402. The sections 1502 may be in some aspects herein rectangular in shape. A dimension A in the X-axis of the section 1502 may be, for example, about 0.5 mm (±1-10%). A dimension B in the X-axis of the other portion 1504 may be, for example, about 2 mm (±1-10%). A dimension C representing the portion of the tape 802 to be slit with a spool is 3 mm (±1-10%). The heat melting adhesive may stay stiff to maintain a shape of the tape and blending it with the filler material may reduce the flow of the heat melting adhesive.

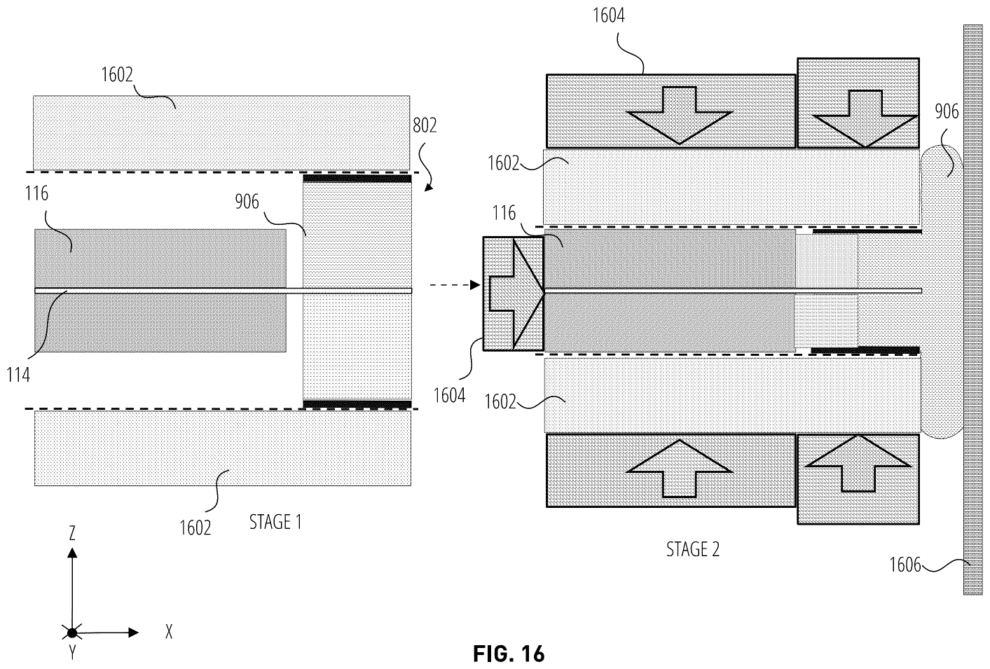

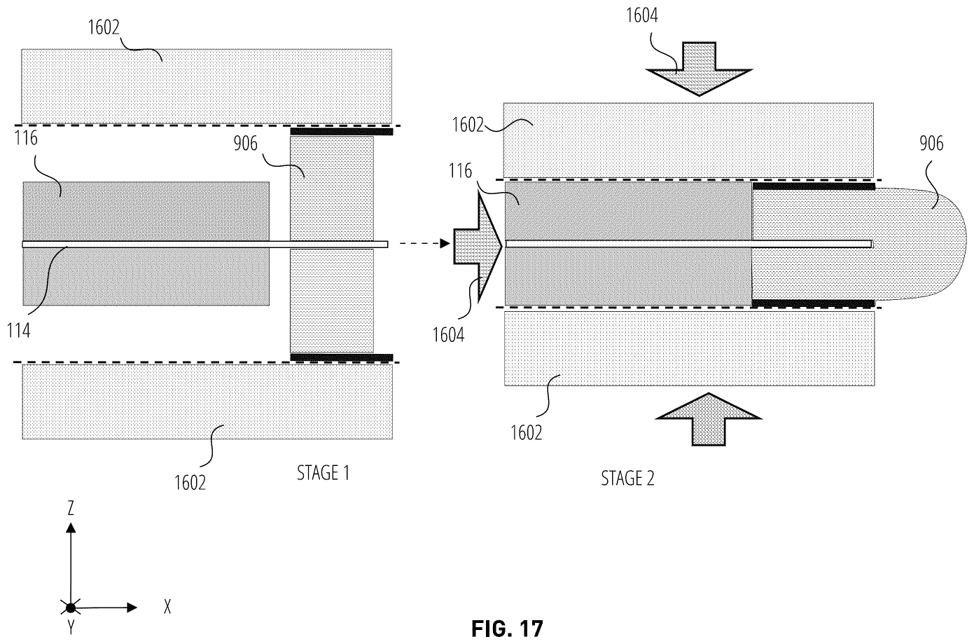

FIG. 16 illustrates a cross sectional view of an electrode, in this case a cathode current collector 114 and cathode active material layer 116, illustrating a compression of a tape 802 in accordance with an illustrative embodiment. As shown in STAGE 1 of FIG. 16, one or more fixtures 1602 may be placed on the sides of the electrode with the tape coated into the abrasion patterns and one or more pressure applicators 1604 may be used to apply pressure, or pressure and heat to compress the tape to fill a whole or substantial portion of the abrasion pattern in STAGE 2 and to cause the middle adhesive layer 906 to move outwardly towards an end of the electrode where applied pressure is lowest. In as aspect, a section 1502 of the tape where the filler material 1402 is added may be displaced minimally whereas the other portions 1504 are displaced to a relatively larger extent. A shaping fixture 1606 disposed at one end of the electrode may deform the outwardly moving middle adhesive layer 906 to form a desired shape. Where there is no shaping fixture 1606, such as what is shown in FIG. 17, a predetermined shape of the middle adhesive layer 906 may otherwise not be formed.

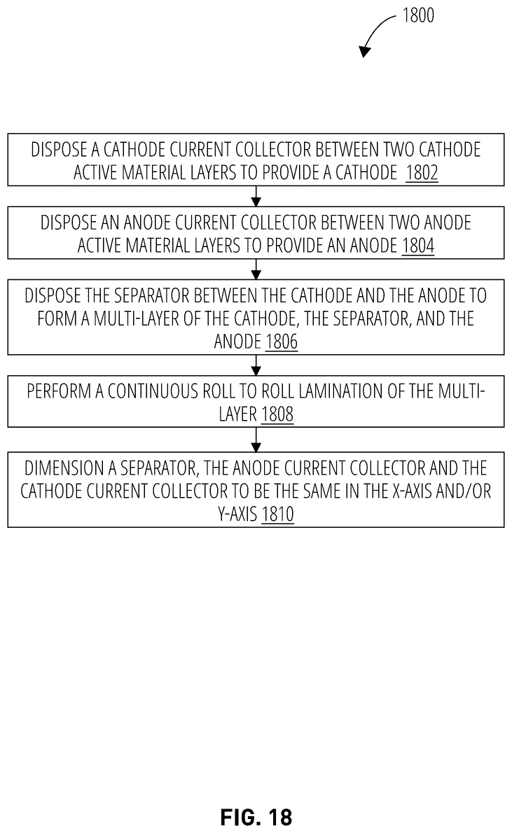

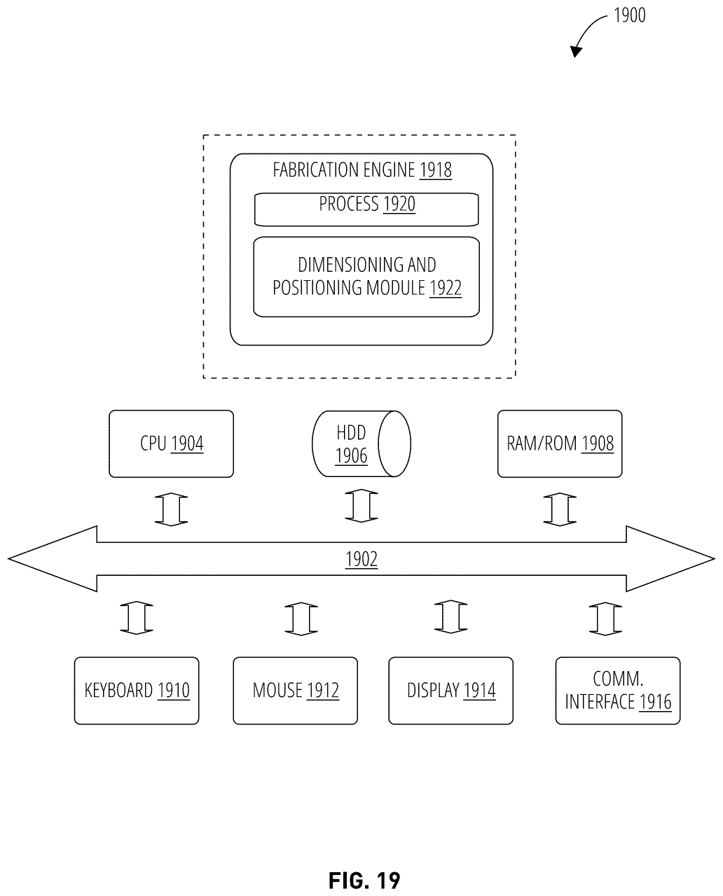

FIG. 18 illustrates a method of manufacturing a cell in accordance with an illustrative embodiment. The method may be performed by the fabrication engine 1918 of FIG. 19. In block 1802, fabrication engine 1918 disposes a cathode current collector between two cathode active material layers to provide a cathode. In block 1804, fabrication engine 1918 disposes an anode current collector between two anode active material layers to provide an anode. In block 1806, fabrication engine 1918 disposes the separator between at least the cathode and the anode to form a multi-layer of the cathode, the separator, and the anode. In some aspects herein, the structure of the multi-layer may be, for example, cathode-separator-anode-separator, or separator-cathode-separator-anode, or separator-anode-separator, or separator-cathode-separator, or separator-anode, separator-cathode. In block 1808, fabrication engine 1918 performs a roll to roll lamination of the multi-layer. In block 1810, fabrication engine 1918 dimensions a separator, the anode current collector and the cathode current collector to be the same in the X-axis and/or Y-axis. The dimensioning may be performed by cutting the continuously laminated material at predetermined intervals using a cutting tool. A mono cell is formed by each cut material and a stack of mono cells may be aligned based on a mechanical positioning system that aligns the stack by manipulating outer edges of the stack which may be common due to dimensioning the separator, the anode current collector and the cathode current collector to be the same. The stack of mono cells may be placed inside a pouch to form a battery cell.

### Example Computer Platform

As discussed above, functions relating to methods and systems for fabricating a cell with an electrode design, that enables continuous roll to roll lamination and improved stacking speed, can use of one or more computing devices connected for data communication via wireless or wired communication. FIG. 19 is a functional block diagram illustration of a computer hardware platform that can be used to control various aspects of a suitable computing environment in which the process discussed herein can be controlled. While a single computing device is illustrated for simplicity, it will be understood that a combination of additional computing devices, program modules, and/or combination of hardware and software can be used as well. The computer platform 1900 may include a central processing unit (CPU) 1904, a hard disk drive (HDD) 1906, random access memory (RAM) and/or read only memory (ROM) 1908, a keyboard 1910, a mouse 1912, a display 1914, and a communication interface 1916, which are connected to a system bus 1902.

In one embodiment, the hard disk drive (HDD) 1906, has capabilities that include storing a program that can execute various processes, such as the fabrication engine 1918, in a manner described herein. The fabrication engine 1918 may have various modules configured to perform different functions. For example, there may be a process module 1920 configured to control the different manufacturing processes discussed herein and others. There may be a dimensioning and positioning module 1922 operable to provide an appropriate dimensioning, mechanical positioning, lamination, and in general, assembly of a cell.

For the sake of brevity, conventional techniques related to making and using aspects of the disclosure may or may not be described in detail herein. In particular, various aspects of manufacturing and computing systems and specific programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A cell comprising:
a pouch extending along a first axis (X-axis) to define a width, a second axis (Y-axis) orthogonal to the first axis to define a length, and a third axis (Z-axis) orthogonal to the first and second axes to define a thickness;
a cathode comprising a cathode current collector disposed between two cathode active material layers;
an anode comprising an anode current collector disposed between two anode active material layers; and
a separator disposed between the cathode and the anode,
wherein a first dimension in the X-axis and/or Y-axis of the separator, the anode current collector and the cathode current collector are the same.

2. The cell of claim 1, wherein:
a second dimension, in the X-axis and/or Y-axis, of the two cathode active material layers is smaller than the second dimension of the two anode active material layers in the X-axis and/or Y-axis, or
the second dimension, in the X-axis and/or Y-axis, of the two cathode active material layers is bigger than the second dimension of the two anode active material layers in the X-axis and/or Y-axis and one or more exposed edges of at least the cathode and/or the anode is sealed.

3. The cell of claim 1, wherein the anode current collector and/or cathode current collector is a polymer current collector.

4. The cell of claim 3, wherein the anode current collector is a polymer anode current collector and comprises a metallized polymer.

5. The cell of claim 4, wherein the metalized polymer comprises a polypropylene (PP) layer disposed between two copper layers.

6. The cell of claim 3, wherein the cathode current collector is a polymer cathode current collector and comprises a metalized polymer.

7. The cell of claim 6, wherein the metalized polymer comprises a polyethylene terephthalate (PET) layer disposed between two aluminum layers.

8. The cell of claim 1, wherein a third dimension of the anode in the Y-axis is the same as the third dimension of the separator in the Y-axis.

9. The cell of claim 1, wherein relative dimensions of components of the cell are configured to enable roll to roll lamination of a plurality of layers of the cell.

10. A method of manufacturing a cell by roll-to-roll lamination comprising:
providing a pouch extending along a first axis (X-axis) to define a width, a second axis (Y-axis) orthogonal to the first axis to define a length, and a third axis (Z-axis) orthogonal to the first and second axes to define a thickness;
disposing a cathode current collector between two cathode active material layers to provide a cathode;
disposing an anode current collector between two anode active material layers to provide an anode;
disposing the separator between the cathode and the anode to form a multi-layer of the cathode, the separator, and the anode;
performing a continuous roll to roll lamination of the multi-layer; and
dimensioning a separator, the anode current collector and the cathode current collector to be the same in the X-axis and/or Y-axis.

11. The method of claim 10, further comprising:
dimensioning the two cathode active material layers to be smaller than the two anode active material layers in the X-axis and/or Y-axis or
dimensioning the two cathode active material layers to be bigger than the two anode active material layers in the X-axis and/or Y-axis and sealing one or more exposed edges of at least the cathode and/or the anode.

12. The method of claim 10, further comprising:
dimensioning by cutting through the multi-layer in the Z-direction during roll-to-roll lamination to form a mono cell.

13. The method of claim 10, further comprising:
stacking a plurality of mono cells together to form a mono cell stack using a mechanical positioning system.

14. The method of claim 13, wherein a stacking speed of the stacking is <0.05 sec/electrode.

15. The method of claim 10, further comprising:
demarcating a section of the multi-layer to be cut during the roll-to-roll lamination by removing a first portion of an active material layer of the cathode and/or anode prior to the roll-to-roll lamination.

16. The method of claim 15, further comprising:
demarcating a section of the multi-layer to be cut during the roll-to-roll lamination by removing a second portion of a metalized polymer in an area of the first portion prior to the roll-to-roll lamination,
wherein the cathode and/or anode comprise a polymer current collector.

17. The method of claim 15, further comprising:
filling the first portion with a tape configured to move outwardly upon pressure application.

18. A tape comprising:
a body extending along a first axis (X-axis) to define a width, a second axis (Y-axis) orthogonal to the first axis to define a length, and a third axis (Z-axis) orthogonal to the first and second axes to define a thickness;
the body further comprising:
a first film layer;
a second middle adhesive layer; and
a third acrylic base adhesive layer;
wherein the second middle adhesive layer is configured to move outwardly (in the X-axis) upon the body receiving a force in the Z-axis while the first film layer and third acrylic base adhesive layer stay intact or substantially intact.

19. The tape of claim 18, wherein the first film layer comprises PET or PI.

20. The tape of claim 18, wherein the first film layer has a thickness in the Z-axis of 10-20 μm.
